(19) United States
(12) Patent Application Publication
(10) Pub. No.: US 2015/0231032 A1
(43) Pub. Date: Aug. 20, 2015

(54) APPARATUS AND METHOD FOR BLOOD COLLECTION

(71) Applicant: VIRGIN HEALTH BANK QSTP-LLC, Doha (QA)

(72) Inventors: Chris Goodman, Doha (QA); Rajan Jethwa, Doha (QA); Mark Fuller, Doha (QA)

(21) Appl. No.: 14/435,134

(22) PCT Filed: Oct. 28, 2013
(86) PCT No.: PCT/IB2013/002660

§ 371 Date: Apr. 10, 2015

(30) Foreign Application Priority Data
Oct. 10, 2012 (GB) 1218205.1

(51) Int. Cl. A61J 1/14; A61J 1/16

(52) U.S. Cl. CPC A61J 1/14; A61J 1/1412; A61J 1/16

(57) ABSTRACT

A device and method for collecting blood are provided. The device comprises a housing configured to receive a blood source and a first collection means in communication with the housing, wherein the housing comprises a first output configured to allow passage of blood extracted from the blood source and/or at least a portion of the blood source therethrough.

### FIELD OF THE INVENTION

The present invention relates to an apparatus and method for collecting blood, such as umbilical cord blood.

### BACKGROUND OF THE INVENTION

Umbilical cord blood remains in the umbilical cord after childbirth. Umbilical cord blood contains stem cells, which can be used to treat a very wide variety of diseases and conditions. Storage of umbilical cord blood and/or stem cells for use at a later date, often referred to as “cell banking”, is now possible and, as a result, devices and methods which effectively extract umbilical cord blood have become highly desirable.

Previous attempts to extract stem cell-containing blood from umbilical cords have mostly involved the use of needles inserted directly into the postpartum cord. It is known to use a syringe to draw blood manually from an umbilical cord for banking. It is also known to pierce the umbilical cord and allow gravity to force blood droplets out of the cord into a collection bag beneath the cord.

However, these previous attempts are not as efficient as they can be. Drawing blood out of a cord using a syringe only allows for the extraction of a very small quantity of blood. Moreover, similar existing cord blood collecting devices are incorporated into metal carts, are non-disposable, minimally transportable, and cumbersome, making them unsuitable for supply to medical institutions as single use, sterile kits. Therefore, there is a need for a blood collecting device which is efficient, fast, easy to use, neat, disposable and sterile, and which allows larger quantities of blood to be extracted with reduced contamination.

### SUMMARY OF THE INVENTION

The device and method of the present invention are designed to overcome these and other problems.

In view of the foregoing and in accordance with an aspect of the invention, there is provided a device for collecting or harvesting blood comprising a housing configured to receive a blood source and a first collection means in communication with the housing, wherein the housing comprises a first output configured to allow passage of blood extracted from the blood source and/or at least a portion of the blood source therethrough.

The device may be configured to allow for collection of blood from the blood source using a gravitational force.

The first output may be configured to allow passage of blood extracted from the blood source therethrough, and the device may further comprise a second output configured to allow passage of at least a portion of the blood source therethrough.

By providing separate outputs for the waste and the blood source, waste can be easily separated from useful products. For example, in an embodiment where the blood source is an umbilical cord and placenta, a portion of the cord can be fed through the second output and blood can be collected. Waste from the placenta and cord can be passed through the first output and collected for disposal.

A first collection means may be in communication with the housing via the first output. The first collection means may threadingly or pushingly engage the housing at the first output.

The device may further comprise a second collection means in communication with the second output. The housing may comprise the second output.

The device may further comprise a pressure-exerting means configured in use to exert pressure on the blood source.

The provision of a pressure exerting means allows pressure to be exerted on the blood source to force blood out of the blood source effectively and efficiently. This method is faster and more effective than existing extraction means such as, for example, drawing blood using a syringe, which only allows a small quantity of blood to be extracted.

At least a portion of the pressure-exerting means may be located within the housing.

The pressure-exerting means may comprise an inflatable located within the housing and an inflation means in communication with the inflatable which may extend outside the housing, wherein the inflation means may comprise a conduit configured to transfer fluid, for example, from outside the housing into the inflatable to inflate the inflatable thereby exerting pressure on the blood source. The inflation means may further comprise a pump located outside the housing and in communication with the conduit, wherein the pump may be configured to force fluid through the conduit and into the inflatable. The fluid may be a gas, such as air, or a liquid. The inflatable may be a sack, balloon, pouch or other inflatable.

The inflatable can be inflated within the housing which contains the blood source. The inflation of the inflatable will cause a subsequent increase in pressure within the housing and, therefore, will exert pressure on the blood source to force blood out of the blood source. This is a highly advantageous means for exerting pressure on a blood source, since it can be initiated without any need to open the housing, owing to the inflation means which transfers fluid, for example a gas such as air, from outside the housing into the inflatable. Therefore, crucially, a sterile environment can be maintained within the housing whilst pressure is being applied to the blood source to draw blood from the blood source.

The device may further comprise a closure configured when in a closed position to close the housing.

The closure serves two key functions. Firstly, it allows for a substantially sterile, or aseptic, environment within the housing. Secondly, it allows for a seal, e.g. a substantially airtight housing interior, meaning that the pressure within the housing increases significantly and efficiently when the inflatable is inflated, further encouraging the extraction of blood from the blood source.

The closure may be releasably attached to the housing or hingedly attached to the housing. This allows a user to open the housing easily to retrieve the contents of the housing or to clean the housing. The use of a hinged closure also has the advantage of simplifying manipulation of the device in use.

The closure in the closed position may be permanent, semi-permanent, or designed for a single use. Such a closure, in the closed position, is resistant to opening. This has the advantage of preventing the opening, e.g. accidental re-opening, of a closed (used) device.

In an alternative embodiment, the first collection means may comprise the second output.

At least a portion of the housing may be substantially conical or frustoconical. The housing may be a funnel. A conical, frustoconical or funnel-shaped housing is advantageous as it is effective to urge the contents of the housing towards the outputs. The housing may be movable between a deployed configuration and a collapsed configuration. The housing may be collapsible, for example, in a concertinaing manner.

The blood source may comprise an umbilical cord and/or a placenta. The blood extracted from the blood source may contain stem cells, for example umbilical cord stem cells.

The housing may be configured in use to receive the placenta and the second collection means may configured in use to be in communication with the umbilical cord. This way, the umbilical cord and placenta can be arranged in situ with the placenta in the housing and the umbilical cord passing through the second outlet and passing blood into the second collection means.

At least a portion of the device may be constructed from surgical grade plastic. The entire device may be constructed from surgical grade plastic. The device may be a disposable device e.g. single-use, non-reusable. Providing a disposable device is advantageous as it means that the device can be supplied to medical institutions as an easy to use, one-time use kit, promoting hygiene, simplicity of use and convenient disposal. Kits, such as disposable or single-use kits, are advantageous as they can be supplied in a compact and sterile form for one-time use and the used device can be disposed of safely, neatly and hygienically. Instructions for assembly and/or use and/or disposal can be supplied with the kit. The kit can optionally include a disposal means or container e.g. a hygienic disposal bag or receptacle which can be made from surgical grade plastic and which can be used to dispose of the used device safely, neatly and hygienically.

The device may further comprise a retaining means for retaining the device on a mounting. The retaining means may be a hook or hanger. The retaining means makes the device suitable for attachment to a piece of medical equipment or furniture.

There is also provided a method for collecting or harvesting blood from a blood source comprising inserting a blood source into a blood collecting device, and collecting blood from the blood source.

The method may comprise using a gravitational force to collect blood from the blood source.

The method may comprise applying pressure to the blood source whilst the blood source is contained within the housing.

The blood collecting device may be the device of the present invention.

Umbilical cord blood stem cells are obtained from term umbilical cord after parturition, and are not embryonic stem cells. Umbilical cord blood stem cells are not capable of developing into an embryo. Obtaining and using umbilical cord blood stem cells does not involve the destruction of human embryos, and obtaining umbilical cord blood cells avoids the controversy and ethical considerations surrounding the provision and use of human embryonic stem (ES) cells.

### BRIEF DESCRIPTION OF THE DRAWINGS

The invention will now be described by way of example with reference to the accompanying drawings, in which:

FIG. 1 is a side view of a first exemplary configuration of a blood-collecting device according to the present invention;

FIG. 2 is a side view of a second exemplary configuration of a blood-collecting device according to the present invention.

### DETAILED DESCRIPTION OF THE DRAWINGS

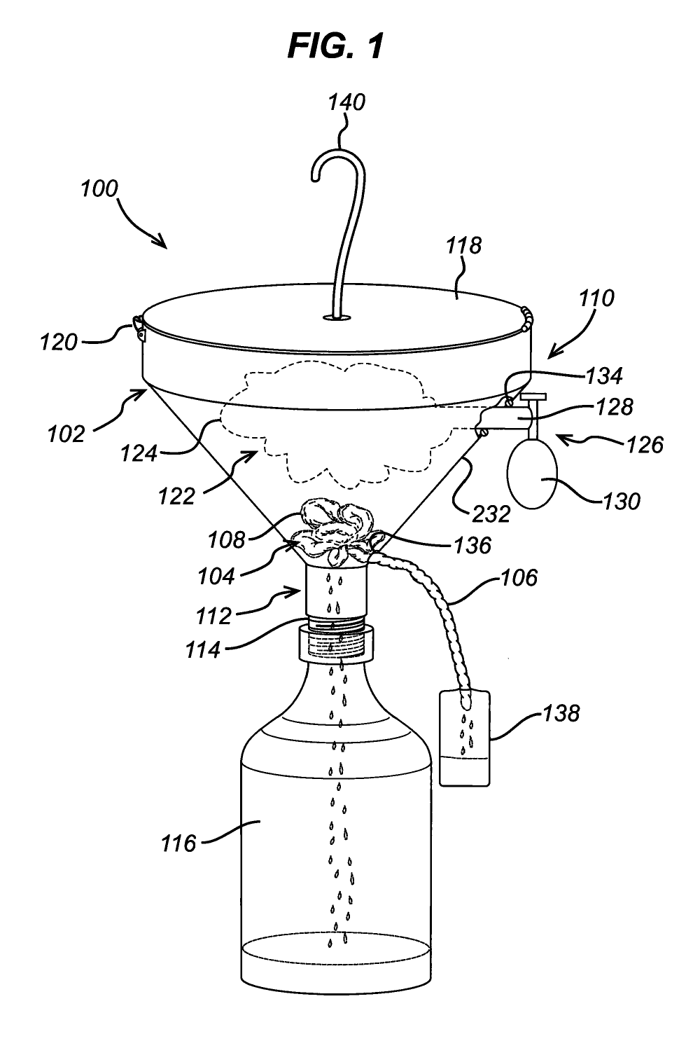

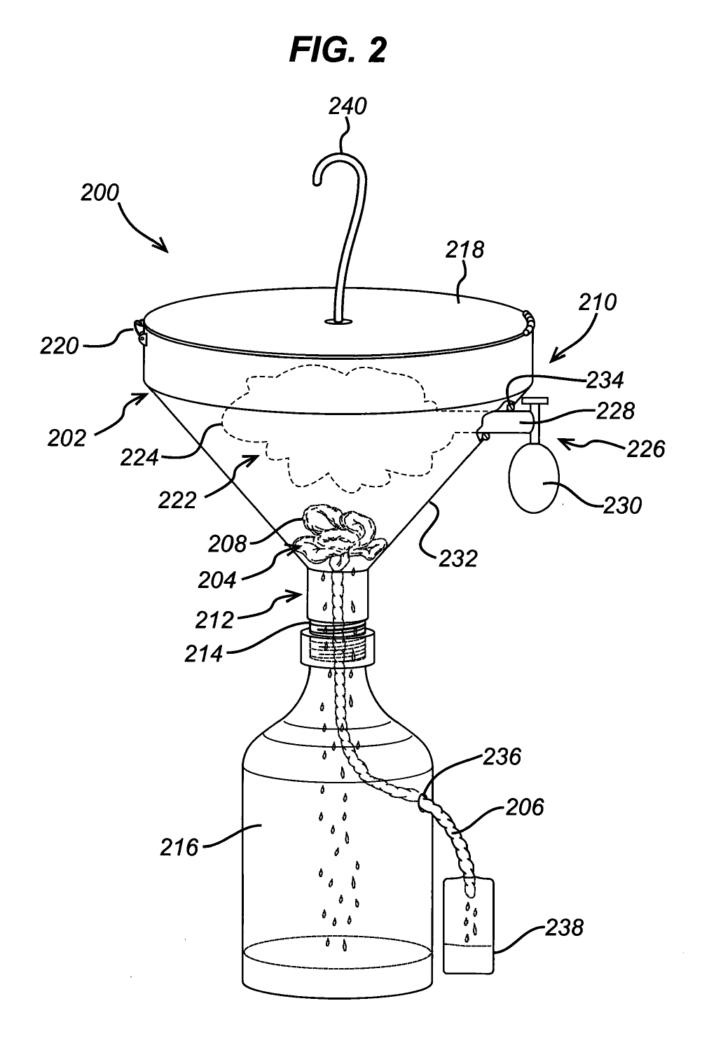

FIGS. 1 and 2 show exemplary configurations of a blood-collecting device 100, 200 according to the present invention. The device comprises a housing 102, 202 configured to receive a blood source 104, 204. In the exemplary embodiments shown in the figures, the blood source 104, 204 is an umbilical cord 106, 206 and placenta 108, 208 which have previously been detached from a human body.

The housing 102, 202 shown in the figures has a substantially conical portion 108, 208 and generally takes the form of a funnel i.e. having a wide portion at a top end 110, 210 of the housing 102, 202 and tapering gradually inwards to a narrow bottom end 112, 212 of the housing 102, 202. The skilled person will understand that a housing having any other suitable shape (e.g. frustoconical, bowl-shaped, cylindrical) could equally be used. The housing 102, 202 comprises a first output 114, 214, which takes the form of a gap or hole located at the narrow end of the housing 102, 202. Alternatively, the first output 114, 214 can be a removable cover, a permeable membrane, a thinning, or any other output through which a blood source and/or waste from a blood source could pass. In some embodiments, the housing is movable between a deployed configuration and a collapsed configuration, for example, in a concertinaing manner.

A first collection means 116, 216 is in communication with the housing 102, 202 via the first output 114, 214. FIGS. 1 and 2 show the first collection means 116, 216 in threaded engagement with (i.e. screwed onto) the housing 102, 202 at the first output 114, 214. The first collection means 116, 216 can alternatively pushingly engage the housing 102, 202 at the first output 114, 214. A closure 118, 218, such as a lid and/or membrane, is also provided to close or seal the housing 102, 202. In some embodiments, the closure 118, 218 is hingedly attached to the housing 102, 202 and/or releasably attached to the housing 102, 202 by means of a latch or clip 120, 220. The first collections means 116, 216 can, for example, take the form of a wind sock, a flask, or any other suitable bag or container.

The device also comprises a pressure-exerting means 122, 212, at least a portion of which is contained within the housing 102, 202. The pressure-exerting means 122, 212 shown in FIGS. 1 and 2 comprises an inflatable, such as an inflatable sack 124, 224, located within the housing 102, 202 and an inflation means 126, 226 in communication with the inflatable 124, 224 and extending outside the housing 102, 202. The inflatable can alternatively be an inflatable balloon, inflatable pouch, or any other inflatable. The inflation means 126, 226 comprises a conduit 128, 228 configured to transport fluid from outside the housing 102, 202 into the inflatable 124, 224 to inflate the inflatable. The inflation means also optionally comprises a pump 130, 230 located outside the housing 102, 202 and in communication with the conduit 128, 228, wherein the pump 130, 230 is configured to force fluid through the conduit 128, 228 and into the inflatable 124, 224. The figures show the conduit 128, 228 passing through a wall 132, 232 of the housing 102, 202. However, the skilled person will understand that the conduit can also pass through the housing closure 118, 218 or any other portion of the housing 102, 202. It is desirable to ensure a tight seal between the conduit 128, 228 and the closure or housing. A grip or stopper 134, 234, for example a rubber grip or stopper, surrounding the conduit 128, 228 and engaging with the closure or housing can be provided to ensure that an airtight and sterile environment is maintained within the housing 102, 202.

In an exemplary embodiment, the fluid used to inflate the inflatable 124, 224 is a gas, such as air, in which case the inflatable can be an airbag and the pump can be an air pump. Alternatively, a liquid, such as water, can be used to inflate the inflatable 124, 224.

As described above, the housing 102, 202 comprises a first output 114, 214. In the exemplary embodiments shown in the figures, the first output is configured to allow passage of waste from the blood source 104, 204 therethrough. The device 100, 200 also comprises a second output 136, 236, which is configured to allow passage of at least a portion of the blood source 104, 204 therethrough. For example, if the blood source is an umbilical cord 106, 206 and/or placenta 108, 208, the second output 136, 236 is configured to allow passage of the umbilical cord 106, 206 therethrough, meaning that umbilical cord blood passes along or through the umbilical cord, through the second output 136, 236. A second collection means 138, 238 is provided to collect the blood extracted from the blood source. The second collection means 138, 238 is typically a bag or flask, although any other suitable collection means can equally be used.

In the configuration shown in FIG. 1, the housing 100 comprises the second output 136.

In the configuration shown in FIG. 2, the first collection means 216 comprises the second output 236. In other words, the umbilical cord 206 is passed through the first output 214 into the first collection means 216, and is then passed through the second output 236 and into the second collection means 238.

In both configurations shown in the figures, the second output is smooth and rounded without any sharp edges so as not to risk tearing the umbilical cord and spilling umbilical cord blood. The second output is a gap or hole on a wall of the housing through which an umbilical cord can pass. Alternatively, the second output is a thinning or a removable cover.

An exemplary method of using the device 100, 200 of the present invention will be described with reference to the figures. The closure 118, 218 is moved to an open position or removed from the housing 102, 202, and a blood source 104, 204, such as an umbilical cord 106, 206 and/or a placenta 108, 208 is placed into the housing 102, 202. The umbilical cord 106, 206 is passed through the second output 136, 236 so that an end of the umbilical cord extends outside the housing. In some embodiments (not shown), a cord clamp is attached to the umbilical cord, in which case the first and/or second output is sufficiently large to allow passage of a cord clamp therethrough. If the device shown in FIG. 1 is used, the umbilical cord 106 is passed directly through the second output 136 into the second collection means 138. If the device shown in FIG. 2 is used, the umbilical cord 206 is passed through the first output 214 into the first collection means 216, and is subsequently passed through the second output 236 into the second collection means 238. In both configurations, the placenta 108, 208 remains within the housing 102, 202 with the inflatable 124, 224 of the pressure-exerting means. The skilled person will understand that the pressure-exerting means is an optional feature, and that gravity on its own will, in many cases, be sufficient to allow for the extraction of umbilical cord blood from the umbilical cord and/or placenta.

Once the blood source is correctly arranged, the closure 118, 218 is moved to its closed position and the latch or clip 120, 220, if provided, is secured to retain the closure on the housing 102, 202. The first collection means 116, 216 is connected to (e.g. screwed onto or pushed onto) the housing 102, 202 at the first output 114, 214 and the second collection means 138, 238 is arranged near the second output 136, 236. For example, the second collection means 138, 238 may be connected to (e.g. screwed onto or pushed onto) the housing 102, 202 at the second output 136, 236. The umbilical cord 106, 206 may be inserted into the second collection means 138, 238 so as to minimise spillage of umbilical cord blood.

Once the device has been assembled, the inflatable 124, 224 is inflated, for example using the pump 130, 230. As the inflatable 124, 224 expands, it exerts pressure on the blood source within the housing, thereby forcing blood out of the blood source. In the device 100 shown in FIG. 1, blood passes from the placenta 108 and through and/or along the umbilical cord 106, out of the second output 136, and into the second collection means 138 for storage. In the device 200 shown in FIG. 2, blood passes from the placenta 208 and through/along the umbilical cord 206, through the first output 214 into the first collection means 216 (but remaining within the umbilical cord), and then out of the second output 236 and into the second collection means 238 for storage.

In the embodiment shown in FIG. 1, the first output 114 is configured to allow passage of waste tissue and/or fluid from the placenta and/or umbilical cord therethrough. This waste then passes into the first collection means 116 and is disposed of.

In the embodiment shown in FIG. 2, the first output 214 is configured to allow passage of the umbilical cord and waste tissue and/or fluid from the placenta and/or umbilical cord therethrough. The umbilical cord then passes out of the first collection means 216 through the second output 236, leaving the waste in the first collection means 216 for disposal.

It is advantageous for the device 100, 200 of the present invention to be mountable on a piece of medical equipment e.g. hospital equipment or furniture. To facilitate mounting of the device, a retaining means 140, 240 in the form of a hook or hanger can optionally be provided on the device.

It is also advantageous for the device to be disposable, so that it can be supplied to medical institutions and/or practitioners as a single-use, easy to use kit e.g. single-use, non-reusable. Additionally, a part of the device or the entire device is optionally constructed from surgical-grade plastic. Kits, such as disposable or single-use kits, are advantageous as they can be supplied in a compact and sterile form for one-time use and the used device can be disposed of safely, neatly and hygienically. Instructions for assembly and/or use and/or disposal can be supplied with the kit.

The kit can include a disposal means or container e.g. a hygienic disposal bag or receptacle which can be made from surgical grade plastic and which can be used to dispose of the used device safely, neatly and hygienically.

In some embodiments, the housing 102, 202 is partially or wholly transparent or translucent so that a user can see the degree of inflation of the inflatable from outside the device. A pressure gauge can also be provided which can be accessed and monitored by a user outside the device to ensure that the inflatable is sufficiently inflated to draw blood from the blood source, but not overinflated and at risk of exploding.

The present invention has been described above in exemplary form with reference to the accompanying drawings. It will be understood that many different embodiments of the invention exist, and that these embodiments all fall within the scope of the invention as defined by the following claims.

1. A device for collecting blood comprising:
a housing configured to receive a blood source; and
a first collection means in communication with the housing,
wherein the housing comprises a first output configured to allow passage of waste from the blood source and/or at least a portion of the blood source therethrough.

2. The device of claim 1, wherein the device is configured to allow for collection of blood from the blood source using a gravitational force.

3. The device of claim 1 or claim 2, wherein the first output is configured to allow passage of waste from the blood source therethrough, and wherein the device further comprises a second output configured to allow passage of at least a portion of the blood source therethrough.

4. The device of any one of the preceding claims, wherein a first collection means is in communication with the housing via the first output.

5. The device of any one of the preceding claims, wherein the first collection means threadingly or pushingly engages the housing.

6. The device of any one of the preceding claims, further comprising a second collection means in communication with the second output.

7. The device of any one of claims 3 to 6, wherein the housing comprises the second output.

8. The device of any one of the preceding claims, further comprising a pressure-exerting means configured in use to exert pressure on the blood source.

9. The device of claim 8, wherein at least a portion of the pressure-exerting means is located within the housing.

10. The device of claim 8 or claim 9, wherein the pressure-exerting means comprises:
an inflatable located within the housing; and
an inflation means in communication with the inflatable,
wherein the inflation means comprises a conduit.

11. The device of claim 10, wherein the inflation means extends outside the housing and wherein the conduit is configured to transport a fluid from outside the housing into the inflatable to inflate the inflatable thereby exerting pressure on the blood source.

12. The device of claim 10 or claim 11, wherein the inflation means further comprises a pump located outside the housing and in communication with the conduit, wherein the pump is configured to force the fluid through the conduit and into the inflatable.

13. The device of claim 11 or claim 12, wherein the fluid is a gas.

14. The device of any one of claims 11 to 13, wherein the fluid is air.

15. The device of any one of claims 11 to 12, wherein the fluid is a liquid.

16. The device of any one of the preceding claims, further comprising a closure configured when in a closed position to close the housing.

17. The device of claim 16, wherein the closure is releasably attached to the housing.

18. The device of claim 16 or claim 17, wherein the closure is hingedly attached to the housing.

19. The device of any one of claims 4 to 6, wherein the first collection means comprises the second output.

20. The device of any one of the preceding claims, wherein at least a portion of the housing is substantially conical or frustroconical.

21. The device of any one of the preceding claims, wherein the housing is a funnel.

22. The device of any one of the preceding claims, wherein the blood source comprises an umbilical cord and/or a placenta.

23. The device of claim 22, wherein the housing is configured in use to receive the placenta and the second collection means is configured in use to be in communication with the umbilical cord.

24. The device of any one of the preceding claims, wherein the blood extracted from the blood source contains stem cells.

25. The device of any one of the preceding claims, wherein the blood extracted from the blood source contains umbilical cord stem cells.

26. The device of any one of the preceding claims, wherein at least a portion of the device is constructed from surgical grade plastic.

27. The device of any one of the preceding claims, wherein the entire device is constructed from surgical grade plastic.

28. The device of any one of the preceding claims being a disposable device.

29. The device of any one of the preceding claims, further comprising a retaining means for retaining the device on a mounting.

30. The device of claim 29, wherein the retaining means is a hook or hanger.

31. The device of any one of the preceding claims, wherein the housing is movable between a deployed position and a collapsed position.

32. The device of claim 31, wherein the housing is collapsible in a concertinaing manner.

33. A method for collecting blood from a blood source comprising:
inserting a blood source into a device according to any one of the preceding claims;
and collecting blood from the blood source.

34. The method of claim 33, further comprising using a gravitational force to collect blood from the blood source.

35. The method of claim 33 or claim 34, further comprising applying pressure to the blood source whilst the blood source is contained within the housing.

36. A device as hereinbefore described with reference to and as shown in the accompanying drawings.

37. A method as hereinbefore described with reference to the accompanying drawings.
